(19) United States
(12) Patent Application Publication
(10) Pub. No.: US 2011/0083079 A1
(43) Pub. Date: Apr. 7, 2011

(54) APPARATUS, SYSTEM, AND METHOD FOR IMPROVED TYPE-AHEAD FUNCTIONALITY IN A TYPE-AHEAD FIELD BASED ON ACTIVITY OF A USER WITHIN A USER INTERFACE

(75) Inventors: COLM FARRELL, Research Triangle Park, NC (US); LIAM HARPUR, Research Triangle Park, NC (US); PATRICK J. O'SULLIVAN, Research Triangle Park, NC (US); FRED RAGUILLAT, Research Triangle Park, NC (US); CAROL S. ZIMMET, Research Triangle Park, NC (US)

(73) Assignee: INTERNATIONAL BUSINESS MACHINES CORPORATION, Armonk, NY (US)

(21) Appl. No.: 12/572,999

(22) Filed: Oct. 2, 2009

(51) Int. Cl. G06F 3/00; G06F 3/048

(52) U.S. Cl. 715/739; 715/780

(57) ABSTRACT

An apparatus, system, and method are disclosed for improved type-ahead functionality in a type-ahead field based on activity of a user within a user interface. The method includes identifying a user activity context including one or more activities of a user within a user interface. Each activity includes an associated recipient identifier. The method includes determining a set of potential recipients based on the user activity context. Each potential recipient corresponds to one or more associated recipient identifiers from the user activity context. The method includes registering the set of potential recipients with one or more type-ahead modules of the user interface. The one or more type-ahead modules suggest one or more recipients from the set of potential recipients to autocomplete a type-ahead field managed by the one or more type-ahead modules.

### FIELD OF THE INVENTION

This invention relates to type-ahead functionality and more particularly relates to improved type-ahead functionality in a type-ahead field based on activity of a user within a user interface.

### BACKGROUND

### Description of the Related Art

Electronic communication is a mainstay of modern technology. Typically, when composing many forms of electronic communication, the sender will insert the recipient's address into an address field. In some cases, a type-ahead feature assists the sender when inserting the recipient's address.

Specifically, the type-ahead feature autocompletes, fills in, or displays the addresses of potential recipients to aid a user in determining an addressee. The type-ahead feature typically suggests potential recipients based on characters that the sender has already entered into the address field or in alphabetical order. A type-ahead feature may also suggest recipients and/or addresses that an electronic message has recently been sent to or received from. However, often a sender is still not presented with relevant addresses by the type-ahead feature.

### BRIEF SUMMARY

The present invention has been developed to provide an apparatus, system, and method for improved type-ahead functionality in a type-ahead field based on activity of a user within a user interface that overcome many or all of the above-discussed shortcomings in the art.

The method for improved type-ahead functionality in a type-ahead field based on activity of a user within a user interface includes identifying a user activity context, determining a set of potential recipients, and registering the set of potential recipients.

The method includes identifying a user activity context including one or more activities of a user within a user interface. Each activity includes an associated recipient identifier. The method includes determining a set of potential recipients based on the user activity context. Each potential recipient corresponds to one or more associated recipient identifiers from the user activity context.

The method includes registering the set of potential recipients with one or more type-ahead modules of the user interface. The one or more type-ahead modules suggest one or more recipients from the set of potential recipients to autocomplete a type-ahead field managed by the one or more type-ahead modules.

In one embodiment, the one or more type-ahead modules suggest one or more recipients from the set of potential recipients in response to the user entering one or more characters in the type-ahead field. In one embodiment determining a set of potential recipients further includes correlating the user activity context to the set of potential recipients by mapping one or more associated recipient identifiers associated with the user activity context to the set of potential recipients.

In one embodiment, the method includes detecting a user-initiated selection of the type-ahead field. In a further embodiment, the method includes suggesting one or more recipients from the set of potential recipients to autocomplete the type-ahead field.

In one embodiment, the method includes monitoring one or more software applications of the user interface and identifying activities of the user with the one or more software applications. In one embodiment, the method includes modifying a pre-existing set of suggested recipients in a type-ahead module of the user interface according to the set of potential recipients. The type-ahead module suggests one or more recipients from the set of potential recipients to autocomplete a type-ahead field.

In one embodiment, the method includes receiving configuration information from the user. The configuration information specifies one or more of a source for activities of a user, a maximum age of activities of a user, and a size limit of the set of potential recipients.

An apparatus and computer program product are also presented for improved type-ahead functionality in a type-ahead field based on activity of a user within a user interface, each providing a plurality of components, modules, and operations to functionally execute the necessary steps described above in relation to the method. In addition, in one embodiment, the apparatus includes a storage module that stores the set of potential recipients wherein the set of potential recipients is accessible to the one or more type-ahead modules. In one embodiment, the apparatus includes a prioritization module that assigns a priority weight to each potential recipient in the set of potential recipients and prioritizes the set of potential recipients based on the priority weights. In a further embodiment, the priority weight of a potential recipient is based on one or more of an amount of time spent by the user on an activity associated with the potential recipient, a frequency of the activity associated with the potential recipient, and an amount of time since the activity associated with the potential recipient.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one embodiment of a hardware system capable of executing an embodiment for improved type-ahead functionality in a type-ahead field based on activity of a user within a user interface;

FIG. 2 is a schematic block diagram illustrating one embodiment of a system for improved type-ahead functionality in a type-ahead field based on activity of a user within a user interface in accordance with the present invention;

FIG. 3 is a schematic block diagram illustrating one embodiment of an apparatus for improved type-ahead functionality in a type-ahead field based on activity of a user within a user interface in accordance with the present invention;

FIG. 4 is a detailed schematic block diagram illustrating another embodiment of an apparatus for improved type-ahead functionality in a type-ahead field based on activity of a user within a user interface in accordance with the present invention;

FIG. 5 is a schematic flow chart diagram illustrating one embodiment of a method for improved type-ahead functionality in a type-ahead field based on activity of a user within a user interface in accordance with the present invention; and

FIG. 6 is a detailed schematic flow chart diagram illustrating another embodiment of a method for improved type-ahead functionality in a type-ahead field based on activity of a user within a user interface in accordance with the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

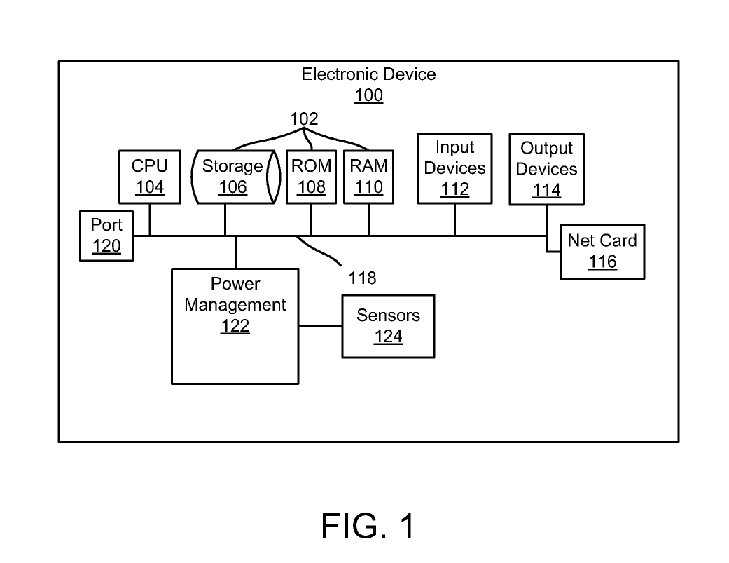

FIG. 1 illustrates one embodiment of an electronic device 100 suitable for executing computer program code for one or more embodiments of the present invention. In certain embodiments, the electronic device 100 is a computer. The electronic device 100 may constitute any type of electronic equipment, including a tablet computer, a PDA, and the like.

The electronic device 100 may include a processor or CPU 104. The CPU 104 may be operably coupled to one or more memory devices 102. The memory devices 102 may include a non-volatile storage device 106 such as a hard disk drive or CD ROM drive, a read-only memory (ROM) 108, and a random access volatile memory (RAM) 110.

The computer in general may also include one or more input devices 112 for receiving inputs from a user or from another device. The input devices 112 may include a keyboard, pointing device, touch screen, or other similar human input devices. Similarly, one or more output devices 114 may be provided within or may be accessible from the computer. The output devices 114 may include a display, speakers, or the like. A network port such as a network interface card 116 may be provided for connecting to a network.

Within an electronic device 100 such as the computer, a system bus 118 may operably interconnect the CPU 104, the memory devices 102, the input devices 112, the output devices 114, the network card 116, and one or more additional ports. The ports may allow for connections with other resources or peripherals, such as printers, digital cameras, scanners, and the like.

The computer also includes a power management unit in communication with one or more sensors. The power management unit automatically adjusts the power level to one or more subsystems of the computer. Of course, the subsystems may be defined in various manners. In the depicted embodiment, the CPU 104, ROM 108, and RAM 110 may comprise a processing subsystem. Non-volatile storage 706 such as disk drives, CD-ROM drives, DVD drives, and the like may comprise another subsystem. The input devices 712 and output devices 114 may also comprise separate subsystems.

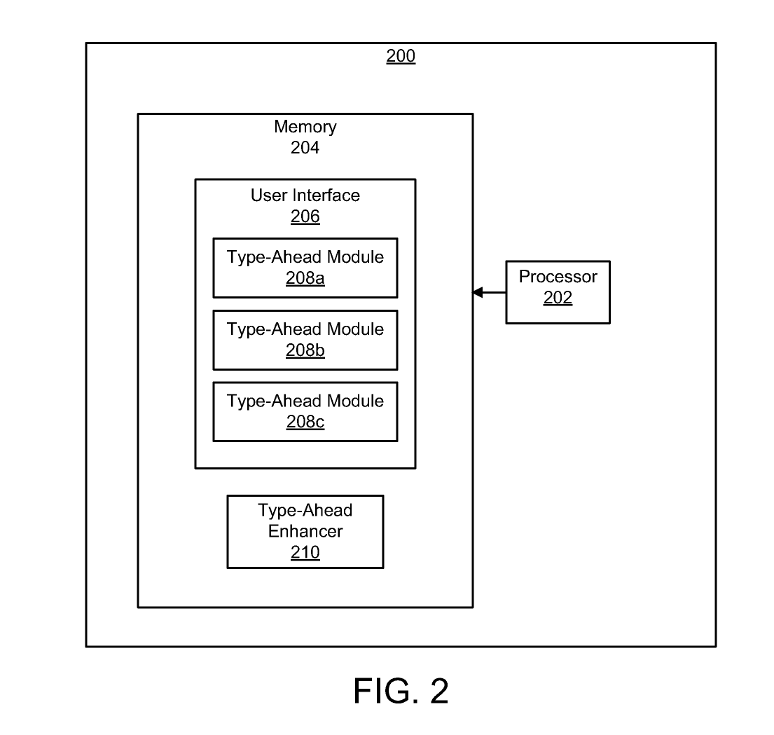

FIG. 2 illustrates one embodiment of a system 200 for improved type-ahead functionality in a type-ahead field based on activity of a user within a user interface in accordance with the present invention. The system 200 includes a processor 202, a memory 204, a user interface 206, a plurality of type-ahead modules 208a-c, and a type-ahead enhancer 210. The system 200 may be embodied by the electronic device 100 depicted in FIG. 1. The processor 202 may be embodied by the CPU 104 depicted in FIG. 1. Likewise, the memory 204 may also be embodied by one or more of the memory devices 102 depicted in FIG. 1.

The user interface 206 may be embodied as an application that allows a user to interact with an electronic device 100 as is known in the art. The user interface 206 may include an application running on an electronic device 100 such as a computer. The user interface 206 may by embodied as an operating system, or an operating system executing one or more applications, on a computer, a cell-phone, a handheld computing device, a portable computer, a server, a mainframe, and the like. The user interface 206 may allow a user to enter input through the input devices 112 of the electronic device 100 and may also provide output to the user in the form of visual or auditory signals.

The user interface 206 includes a plurality of type-ahead modules 208a-c. Although three type-ahead modules 208a-c are depicted, one skilled in the art realizes that more or less type-ahead modules 208 may be included in the user interface 206. Each type-ahead module 208 provides type-ahead functionality to one or more type-ahead fields. Type-ahead functionality anticipates and provides or suggests text that a user may intend to type into a particular field. For example, a user may intend to type john@company.com and as the user types the character “j” into the type-ahead filed, a type-ahead module suggests john@company.com to the user. The user may select the suggested address.

Type-ahead functionality may provide a single suggested text element, or a list of text elements. The user may select a text element from the suggested text element or the list of text elements. In addition, type-ahead functionality may also autocomplete a type-ahead field by automatically filling-in a type-ahead field with a suggested text element. To autocomplete a type-ahead field means to automatically fill-in a type-ahead field with text or fill-in the type-ahead field with text subject to the user's approval and/or final selection of the filled-in text as is known in the art.

A type-ahead module 208 comprises a set of logic that serves to manage one or more type-head fields to provide type-ahead functionality. Each type-ahead module 208 implements type-ahead functionality in the user interface 206 or one or more applications running on the user interface 206. The type-ahead modules 208 may be integrated with an application, or may be utilized by an application such as through an Application Programming Interface (“API”) of an operating system or of a stand-alone API.

A type-ahead module 208 typically serves to anticipate or suggest a potential recipient of an electronic communication to a user. Potential recipients include those individuals and/or electronic addresses to which a user sends an electronic communication. The type-ahead modules 208 may suggest potential recipients by referencing a list of contacts including at least one or more electronic addresses, and/or a name associated with the electronic addresses. Certain conventional type-ahead modules 208 may refer to a list of potential recipients to which the user has recently sent electronic communication when suggesting potential recipients. For instance, a type-ahead module 208 may prioritize based on a potential recipient to which the user has just sent an email to.

Furthermore, the type-ahead modules 208 may also suggest potential recipients in response to the user entering one or more characters in the type-ahead field. As is known in the art, the type-ahead module 208 may narrow the list of potential recipients based on a character or characters entered into the type-ahead field by the user. For example, if the user enters the letter “A,” the type-ahead module 208 may suggest names and/or electronic addresses that begin with the letter “A.” Additional characters may further limit the suggested potential recipients.

A type-ahead field may include an input field, text box, address field, or other similar input space in an electronic communication on the user interface 206 to enter or indicate an address, name, or message recipient. The type-ahead field may include a field or box as described above that has type-ahead functionality. This type of type-ahead resolution can apply to any name field specification such as meeting invites, instant messaging, name search fields, and the like.

The memory 204 also includes the type-ahead enhancer 210. Although the type-ahead enhancer 210 is depicted as a separate entity from the user interface 206, in certain embodiments, the type-ahead enhancer 210 may be integrated within the user interface 206. Furthermore, in another embodiment, the type-ahead enhancer 210 resides on a separate electronic device 100 in communication with the user interface 206 on the electronic device 100. One skilled in the art realizes that the type-ahead enhancer 210 may be configured in a variety of ways while still maintaining the same or similar functionality.

A type-ahead enhancer 210 serves to anticipate potential recipients by taking into account user-specific circumstances to more accurately anticipate to whom the user wishes to send electronic communication. Specifically, the type-ahead enhancer 210 uses the activities and user activity context of the user to maintain and provide a list of potential recipients to type-ahead modules 208 of the user interface 206. As used herein, an “activity” of a user includes but is not limited to various electronic actions within the user interface 206 that a user may initiate or perform such as opening a document, sending an email, running a specific software application, viewing a blog, viewing a website, engaging in an electronic communication such as email, chat, instant messaging, and the like.

The user activity context aids the type-ahead enhancer 210 to determine potential recipients that are more relevant to the user. As used herein, a user activity context comprises the identity of the user, activities that the user has done/is doing, and when the user did those activities. For example, the identity of the user may include the job title of the user, the department the user works in, projects that the user is working on, and the like. The user activity context 308 helps determine the relevancy of potential recipients. Often, a user will perform various electronic activities related to a particular subject matter. These activities may also be included in the user activity context. For example, a user may access several documents related to “testing” and send emails regarding testing projects. The user activity context may reflect these testing oriented activities and the type-ahead enhancer 210 may use information about these activities include members of the testing department as potential recipients. In addition, the time period in which the user performed/is performing the activities may also be included in the user activity context. For example, a user may be more likely to send electronic communication to potential recipients involved in activities from the last day than potential recipients involved in activities from a week ago.

Therefore, a conventional type-ahead module 208 may prioritize a recipient to whom the user had just immediately sent an email. When the user proceeds to send another electronic communication and brings up a type-ahead field, the conventional type-ahead module 208 may suggest the recipient as a potential recipient. However, if the recipient is one to which the user rarely sends an email, the chances of that recipient being relevant as a potential recipient for future emails is low. In the same example, the type-ahead enhancer 210 uses the user activity context to determine other factors in suggesting potential recipients such as the frequency of communication with a recipient, whether a recipient is associated with activities the user is engaged in, or has recently been engaged in, and the like.

For example, if a user has a significant aspect to his or her recent activities, (the user is using “test” related websites, test applications and writing “test” in a text application) then the type-ahead enhancer 210 may prioritize potential recipients according to whether they have test related skills or they are in a testing department.

The type-ahead enhancer 210 may provide the potential recipients to the type-ahead modules 208. In certain embodiments, the type-ahead enhancer 210 directly interfaces with a type-ahead field to suggest potential recipients. As a result, the user is provided with potential recipients in a type-ahead field that have a higher probability of being relevant to the user.

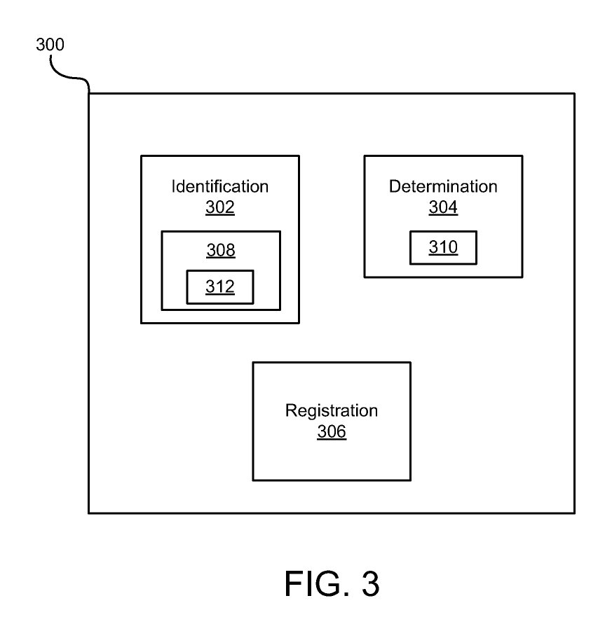

FIG. 3 illustrates one embodiment of an apparatus 300 for improved type-ahead functionality in a type-ahead field based on activity of a user within a user interface 206 in accordance with the present invention. The apparatus 300 constitutes one embodiment of the type-ahead enhancer 210 and includes an identification module 302, a determination module 304, and a registration module 306.

Because a user is more likely to send electronic communication to recipients with which the user is currently interacting (either directly or indirectly), the identification module 302 identifies a user activity context 308 that includes the identity of the user, one or more activities 312 of the user, and the time period in which the activities 312 are/were performed help determine the relevancy of potential recipients.

In one embodiment, the identification module 302 references information about the user from a user profile. For example, the user may enter a company name, job title, project name, and the like when the user initializes the type-ahead enhancer 210. This information may be used by the identification module 302 to determine an identity of the user. In another embodiment, the identification module 302 references user identity information from other software applications on the user interface 206. One skilled in the art realizes the variety of ways in which the identification module 302 may locate user identity information.

In one embodiment, the identification module 302 uses time as a factor in identifying a user activity context 308. For example the identification module 302 may identify a user activity context 308 based on the most recent activities 312 of the user. In one embodiment, a user may configure how the identification module 302 determines what constitutes a recent activity 312. For example, a user may specify that the identification module 302 classify activities 312 as recent activities 312 when those activities 312 were performed within one day. In another embodiment, the identification module 302 assigns a weight according to when the activity 312 was performed with activities 312 receiving less weight as they age. One skilled in the art realizes the variety of ways in which the identification module 302 may determine recent activities 312.

In another embodiment, the identification module 302 identifies a user activity context 308 based on activities 312 during a time period corresponding to a task in the user's calendar. For example, if a user's calendar has a task scheduled for a particular time period and the task has the keyword “testing evaluation,” the identification module 302 may identify a user activity context 308 with the keywords “testing” and “evaluation” for the activities 312 of the user during the particular time period.

In addition, in one embodiment, the identification module 302 identifies a plurality of user activity contexts 308. For example, one user activity context 308 may apply during working hours and specifies a business context while another user activity context 308 may apply after working hours, specifying a personal context. The identification module 302 may identify and track a plurality of user activity contexts 308, the current context, or the most recent context.

The activities 312 of a user within a user interface 206 included in the user activity context 308 may include one or more electronic activities as described above. Furthermore, in one embodiment, the identification module 302 identifies activity details related to each activity 312.

Activity details may specify details about the activity 312 such as what kind of document was accessed, the recipient of the email, the program that was executed, and the like. Activity details may also specify further details such as the title of the document, the subject of the email, key words in the document, metadata associated with the document, and the like. Activity details may also include the length of time spent on the activity 312, the number of times a particular recipient was emailed, and the like.

For example, the identification module 302 may identify the user accessing a text document as an activity 312. The identification module 302 further identifies activity details such as the document author obtained from the document metadata, the title of the document, and the date the document was last modified.

Activities 312 and activity details may define a user activity context 308. For example, if an author of the text document in the above example works in the testing department and the title of the document includes the term “test,” the user activity context 308 may be defined as actions relating to “tests” or “testing.” One skilled in the art realizes that many different forms of data may constitute activities 312 and activity details to define a user activity context 308. The identification module 302, in one embodiment, sorts the actions of the user within the operating system, user interface 206, or another software application into one or more user activity contexts 308 based upon the nature of the activity 312. The nature of the activity 312 may be identified by keywords, the type of program involved in the activity 312, the department or job title of the recipient of an electronic communication, and the like.

In certain embodiments, each activity 312 includes an associated recipient identifier. Specifically, the identification module 302 associates each user activity context 308, through the activities 312, with one or more associated recipient identifiers. An associated recipient identifier is an indicator that may be traced to a potential recipient directly or indirectly. For example, an email address that appears in a text document or email message in the address field or the body of the email is an associated recipient identifier that directly indicates a potential recipient or electronic address. Furthermore, a name that appears in a text document may indirectly indicate a potential recipient because the electronic address associated with that name may require determination. In some embodiments, the type-ahead modules 208 allow a user to designate a recipient using a “familiar name” that the application has associated with an electronic address. Therefore, in these embodiments, a name may directly identify a potential recipient if the name is a familiar name in the application or type-ahead module 208 and is associated with an electronic address.

Moreover, an activity 312 that involves a user typing the term “test” a certain number of times in a text document may have the term “test” as an associated recipient identifier that indirectly indicates potential recipients in the testing department. One skilled in the art realizes that an associated recipient identifier may constitute any number of indicators to specific potential recipients or sources of potential recipients.

In one embodiment, the identification module 302 identifies activities 312 of the user by referencing pre-existing repositories indicative of activities 312. For example, the identification module 302 may reference documents and files in various pre-existing “recent document” tracking repositories provided by applications such as operating systems, word-processing programs, or internet browsers. These repositories often maintain a record of recently accessed documents. The identification module 302 may reference these repositories to identify the activities 312 of the user. For example, the identification module 302 may search the browsing history of a user and determine that the user has accessed several web pages related to software testing.

The determination module 304 determines a set of potential recipients, or recipient set 310 based on the user activity context 308. Each potential recipient corresponds to one or more associated recipient identifiers from the user activity context 308. The determination module 304 may use a set of associated recipient identifiers from the user activity context 308 to determine potential recipients by tracing, or mapping the associated recipient identifiers to one or more potential recipients. The determination module 304, in one embodiment, determines the set of potential recipients based on user configuration settings. For example, a user may configure the determination module 304 to review activities 312 in the user activity context 308 from the last two days.

The determination module 304 may reference a corporate directory, email address book, or other source to match an associated recipient identifier with a potential recipient. For example, if the associated recipient identifier is a name that the identification module 302 identified from a spreadsheet that the user had accessed, the determination module 304 may reference the corporate directory to find an electronic address associated with the name. As mentioned above, in some embodiments, the type-ahead module 208 may only need a familiar name to fill in an address in the type-ahead field. Therefore, in these embodiments, the determination module 304 is not required to reference a name-address directory.

In one embodiment, the determination module 304 performs more advanced recipient identifier to potential recipient mappings based on a topical association for the recipient identifier. For example, if the user activity context 308 is directed at testing and an associated recipient identifier is the term “test department” identified in the body of an email, the determination module 304 may reference the corporate directory for potential recipients in the test department.

The recipient set 310 may be stored and accessed from a variety of data structures known in the art. The recipient set 310 may therefore include a person's name, electronic address, associated recipient identifiers, or a combination. The recipient set 310 may include entries for each potential recipient. Each potential recipient entry may include the recipient's name, title, department, electronic address, and the like. Furthermore, storing the recipient set 310 is described in more detail below.

The registration module 306 provides integration with existing type-ahead modules 208. Specifically, the registration module 306 registers the recipient set 310 with one or more type-ahead modules 208 of the user interface 206. The one or more type-ahead modules 208 may then suggest one or more recipients from the recipient set 310 to autocomplete a type-ahead field managed by the one or more type-ahead modules 208. Registering a recipient set 310 may include inputting the recipient set 310 into a type-ahead module 208, signaling a type-ahead module 208 to reference the recipient set 310, or otherwise interfacing with a type-ahead module 208 to cause the type-ahead module 208 to use some or all of the members of the recipient set 310 for type-ahead suggesting. In certain embodiments, the recipient set 310 replaces a set of recipients the type-ahead module 208 would use. In another embodiment, the recipient set 310 augments a set of recipients the type-ahead module 208 uses. In one embodiment, the registration module 306 registers the recipient set 310 using an Application Programming Interface (“API”) of a type-ahead module 208 or an application in which a type-ahead module 208 is included as is known in the art.

Beneficially, embodiments that register a recipient set 310 with the type-ahead modules 208 permit existing type-ahead modules 208 and addressing applications to be used with the type-ahead enhancer 210. Consequently, the type-ahead enhancer 210 may provide for more potential recipients that are relevant to a user using a variety of applications without the need for expensive code modifications.

In one embodiment, the one or more type-ahead modules 208 suggest one or more recipients from the recipient set 310 in response to the user entering one or more characters in the type-ahead field. As is known in the art, the type-ahead modules 208 may suggest recipients based on characters entered by the user. Furthermore, the list of recipients may be narrowed as the number of characters entered by the user increases.

In another embodiment, the type-ahead modules 208 may suggest one or more recipients without a user entering any characters. For example, if a user opens a new window to compose an email, the type-ahead modules 208 may provide a “drop-down” box with a list of recipients. Additionally, the type-ahead module 208 may suggest one or more recipients in response to a user selecting, activating, or focusing on a type-ahead field.

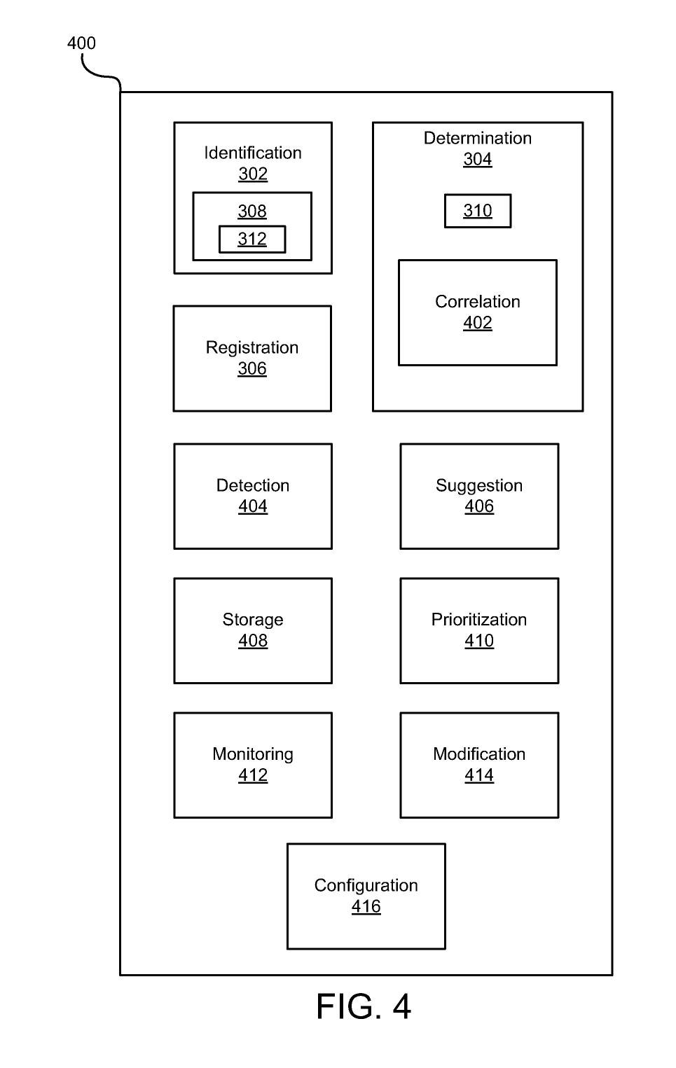

FIG. 4 illustrates another embodiment of an apparatus 400 for improved type-ahead functionality in a type-ahead field based on activity 312 of a user within a user interface 206 in accordance with the present invention. The apparatus 400 includes the identification module 302, the determination module 304, and the registration module 306, wherein these modules include substantially the same features as described above in relation to FIG. 3. Additionally, in one embodiment, the apparatus 400 includes a correlation module 402, a detection module 404, a suggestion module 406, a storage module 408, a prioritization module 410, a monitoring module 412, a modification module 414, and a configuration module 416.

The correlation module 402 converts a user activity context 308 to potential recipients by correlating the user activity context 308 to the recipient set 310. The correlation module 402 correlates the user activity context 308 to the recipient set 310 by mapping one or more associated recipient identifiers associated with the user activity context 308 to the recipient set 310. As described above, the user activity context 308 may include one or more associated recipient identifiers. The correlation module 402 maps these associated recipient identifiers to the recipient set 310. As described above, a user activity context 308 directed at testing may include associated recipient identifiers such as “testing department,” “quality-assurance,” and the like.

The correlation module 402 may establish relationships between these identifiers and potential recipients. For example, the correlation module 402 may refer to the corporate directory to obtain potential recipients in the testing department as described above. In another embodiment, the correlation module 402 searches for potential recipients in emails that include a predetermined number of instances of the text of an associated recipient identifier. One skilled in the art realizes that the correlation module 402 may be implemented in a variety of ways and configured to search for associated recipient identifier-potential recipient mappings in a variety of locations and applications.

In embodiments in which the type-ahead enhancer 210 implements the type-ahead and autocompletion functionality, the detection module 404 detects a user-initiated selection of the type-ahead field. In one embodiment, the recipient set 310 is directly utilized by the type-ahead enhancer 210 to suggest recipients for the user. In this embodiment, the detection module 404 detects an appropriate time and manner in which to provide recipient suggestions. The detection module 404 may detect a user-initiated selection of the type-ahead field in response to a user entering one or more characters in the type-ahead field, a user opening a new window to compose an email, or a user selecting, activating, or focusing on a type-ahead field. One skilled in the art realizes that the detection module 404 may detect a user-initiated selection of the type-ahead filed in a variety of ways.

In embodiments in which the type-ahead enhancer 210 implements the type-ahead and autocompletion functionality, the suggestion module 406 suggests one or more recipients from the recipient set 310 to autocomplete the type-ahead field. In one embodiment, the suggestion module 406 suggests the one or more recipients in response to the detection module 404 detecting a user-initiated selection of the type-ahead field. The suggestion module 406 may suggest recipients by providing a single suggested text element, or a list of text elements. The user may select a text element from the suggested text element or the list of text elements. In addition, the suggestion module 406 may also autocomplete a type-ahead field by automatically filling-in a type-ahead field with a suggested text element.

The storage module 408 stores the recipient set 310 wherein the recipient set 310 is accessible to the one or more type-ahead modules 208. In one embodiment, the storage module 408 stores the recipient set 310 in a database or a file such as an Extended Markup Language (“XML”) file. The recipient set 310 may be stored in a common format such as XML, Comma separated values (“CSV”), and the like. Furthermore, the storage module 408 may store the recipient set 310 in a location where the type-ahead modules 208 may have access to the set such as in a shared files directory. The storage module 408 may store the recipient set 310 in one or more data structures as is known in the art such as a set, list, linked list, array, tree, queue, map, and the like. In one embodiment, the storage module 408 provides the recipient set 310 on demand in response to a command from the user. For example, the user may wish to view the recipient set 310 to find out how to spell a last name. The user may input a command or make a menu selection to signal the storage module 408 to present the recipient set 310 through the user interface 206 such as through a pop-up window or call out box.

In one embodiment, the recipient set 310 is persistent and is maintained in memory even when the electronic device 100 hosting the set is turned off. The recipient set 310 may be stored or backed up in non-volatile memory. In another embodiment, the recipient set 310 is stored in volatile memory and does not persist when the electronic device 100 is turned off.

In one embodiment, the storage module 408 stores a plurality of sets of potential recipients. As a result, potential recipients collected based on recent activities 312 and associated contexts can be archived and stored for later retrieval. For example, a user may restore and activate the recipient set 310 collected from the previous week for current use.

Likewise, in one embodiment, the storage module 408 also stores one or more user activity contexts 308. The stored user activity contexts 308 may be retrievable in response to a detected action by the user indicating that the user is working under the stored context. For example, if a user types the term “test” in an email subject, the stored context “Testing” may be retrieved and loaded as the current, active user activity context 308. The stored user activity contexts 308 may also be retrievable in response to a signal or command from the user to load a specific context. The storage module 408 may associate one or more sets of potential recipients with a user activity context 308 or a plurality of user contexts.

In certain embodiments, the entries in the recipient set 310 are prioritized to aid in suggested potential recipients. Therefore, the prioritization module 410 assigns a priority weight to each potential recipient in the recipient set 310. In one embodiment, the priority weight of a potential recipient is based on an amount of time spent by the user on an activity 312 associated with the potential recipient, a frequency of the activity 312 associated with the potential recipient, and/or an amount of time elapsed since the activity 312 associated with the potential recipient.

The priority weight may be based on a combination of the above referenced criteria along with other criteria. For example, a potential recipient associated with a document in which the user has had open for four hours may receive a greater priority weight that a potential recipient associated with a document in which the user had had open for one hour. Potential recipients associated with an activity 312 that the user recently performed may be given greater priority weight than those associated with activities in which a greater time has elapsed since the user engaged in the activity 312. One skilled in the art realizes the variety of ways in which priority weights may be assigned and maintained.

The prioritization module 410 also prioritizes the recipient set 310 based on the priority weights. The prioritization module 410 may prioritize the recipient set 310 by changing the order of potential recipients in a data structure representing the recipient set 310. The prioritization module 410 may periodically prioritize the recipient set 310 based on updated priority weights, or may prioritize the recipient set 310 in response to detecting an activity 312 by the user. Furthermore, the prioritization module 410 may prioritize the recipient set 310 as the recipient set 310 is sent to the type-ahead module 208 for display or autocompletion.

The monitoring module 412 monitors one or more software applications of the user interface 206 and identifies activities 312 of the user with the one or more software applications. The monitoring module 412 may be embodied as a thread or process that runs in the background of the user interface 206 to collect and monitor user activity data with software applications running on the user interface 206. For example, when the user opens a text document, the monitoring module 412 may record the opening of the document as an event and scan the document for associated recipient identifiers.

In another embodiment, the monitoring module 412 periodically scans the user interface 206 for evidence of user activities 312 such as indicators stored in the “recent document” archive of software applications running on the user interface 206.

The modification module 414 modifies a pre-existing set of suggested recipients in a type-ahead module 208 of the user interface 206 according to the recipient set 310. In one embodiment, the modification module 414 modifies potential recipient lists inside the type-ahead modules 208. For example, the modification module 414 may detect that a type-ahead module 208 is activated and the modification module 414 may modify the pre-existing recipient set 310 that the type-ahead module 208 would typically present to add potential recipients from the recipient set 310. Consequently, the type-ahead module 208 suggests one or more recipients from the recipient set 310 to autocomplete a type-ahead field.

The configuration module 416 receives configuration information from the user. The configuration information specifies one or more of a source for activities 312 of a user, a maximum age of activities 312 of a user, and a size limit of the recipient set 310. One skilled in the art realizes the variety of user-configurable options for use by the configuration module 416. A user may optionally specify in a profile or preferences that they wish to use this functionality. The scope of the functionality may be set. For example, the user may specify time-based configuration information and activity 312 source information such as “remember activity details for only spreadsheet and text documents that were viewed within two hours prior to using the type-ahead functionality.” The user may be able to set the size of the number of entries in the potential recipient list. The user may specify the data sources to check when mapping activities 312 to names. For example, the user may specify “use the corporate names directory to match activities to potential recipients.”

In one embodiment, the configuration module 416 receives configuration information that determines whether the type-ahead enhancer 210 interfaces with existing type-ahead modules 208 of the user interface or whether the type-ahead enhancer 210 provides the type-ahead functionality.

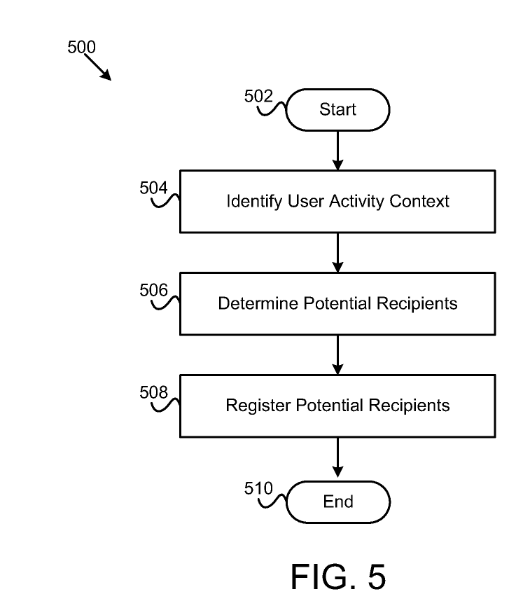

FIG. 5 illustrates one embodiment of a method 500 for improved type-ahead functionality in a type-ahead field based on activity 312 of a user within a user interface 206 in accordance with the present invention. The method 500 starts 502 and the identification module 302 identifies 504 a user activity context 308 including one or more activities 312 of a user within a user interface 206. Each activity 312 includes an associated recipient identifier. The determination module 304 then determines 506 a recipient set 310 based on the user activity context 308, each potential recipient corresponding to one or more associated recipient identifiers from the user activity context 308. Next, the registration module 306 registers 508 the recipient set 310 with one or more type-ahead modules 208 of the user interface 206 and the method 500 ends 510. The one or more type-ahead modules 208 may then suggest one or more recipients from the recipient set 310 to autocomplete a type-ahead field managed by the one or more type-ahead modules 208.

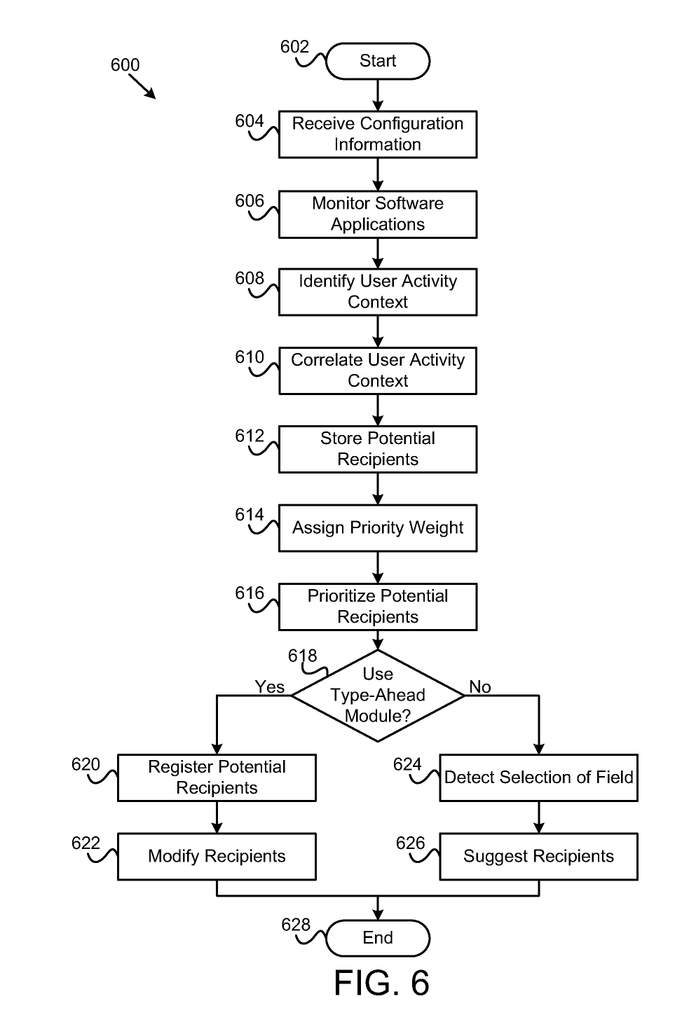

FIG. 6 illustrates another embodiment of a method 600 for improved type-ahead functionality in a type-ahead field based on activity 312 of a user within a user interface 206 in accordance with the present invention. The method 600 begins 602 and the configuration module 416 receives 604 configuration information from the user. The configuration information may specify such things as a source for activities 312 of a user, a maximum age of activities 312 of a user, and a size limit of the recipient set 310. Next, the monitoring module 412 monitors 606 one or more software applications of the user interface 206 and identifies activities 312 of the user with the one or more software applications. The monitoring module 412 may also collect data generated from recent electronic activity 312 to identify activities 312 of the user.

The identification module 302 identifies 608 a user activity context 308 that includes the activities 312 of the user identified by the monitoring module 412. Each activity 312 includes an associated recipient identifier. The correlation module 402 then correlates 610 the user activity context 308 to the recipient set 310 by mapping one or more associated recipient identifiers associated with the user activity context 308 to the recipient set 310. The storage module 408 then stores 612 the recipient set 310 such that the recipient set 310 is accessible to the one or more type-ahead modules 208. The recipient set 310 may be in a common format such as XML for ease of access by a variety of type-ahead modules 208.

The prioritization module 410 assigns 614 a priority weight to each potential recipient in the recipient set 310. The priority weight of a potential recipient may be based on the amount of time spent by the user on an activity 312 associated with the potential recipient, the frequency of the activity 312 associated with the potential recipient, and/or the amount of time since the activity 312 associated with the potential recipient. The prioritization module 410 then prioritizes 616 the recipient set 310 based on the priority weights.

The registration module 306 determines 618 that pre-existing type-ahead modules 208 will be used. Therefore, the registration module 306 registers 620 the recipient set 310 with the type-ahead modules 208 of the user interface 206. The modification module 414 modifies 622 a pre-existing set of suggested recipients in one or more type-ahead modules 208 of the user interface 206 according to the recipient set 310. Thus, potential recipients from the recipient set 310 are added to the recipient list maintained by the type-ahead modules 208. As a result, the one or more type-ahead modules 208 may suggest one or more recipients from the recipient set 310 to autocomplete a type-ahead field managed by the one or more type-ahead modules 208. Then, the method 600 ends 628.

Alternatively, the registration module 306 determines 618 that pre-existing type-ahead modules 208 will not be used by the type-ahead enhancer 210 and that the type-ahead enhancer 210 will suggest potential recipients. The detection module 404 detects 624 a user-initiated selection of the type-ahead field. The detection module 404 may detect a user-initiated selection in response to the user opening a window for electronic communication, place the cursor in an address field, begin typing characters in an address field, and the like. Then, the suggestion module 406 suggests 626 one or more recipients from the recipient set 310 to autocomplete the type-ahead field, and the method 600 ends 628.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for improved type-ahead functionality in a type-ahead field based on activity of a user within a user interface, the method comprising:
identifying a user activity context comprising one or more activities of a user within a user interface, each activity comprising an associated recipient identifier;
determining a set of potential recipients based on the user activity context, each potential recipient corresponding to one or more associated recipient identifiers from the user activity context; and
registering the set of potential recipients with one or more type-ahead modules of the user interface, wherein the one or more type-ahead modules suggest one or more recipients from the set of potential recipients to autocomplete a type-ahead field managed by the one or more type-ahead modules.

2. The method of claim 1, wherein the one or more type-ahead modules suggest one or more recipients from the set of potential recipients in response to the user entering one or more characters in the type-ahead field.

3. The method of claim 1, further comprising
detecting a user-initiated selection of the type-ahead field; and
suggesting one or more recipients from the set of potential recipients to autocomplete the type-ahead field.

4. The method of claim 1, wherein determining a set of potential recipients further comprises correlating the user activity context to the set of potential recipients by mapping one or more associated recipient identifiers associated with the user activity context to the set of potential recipients.

5. The method of claim 1, further comprising monitoring one or more software applications of the user interface and identifying interaction activities of the user with the one or more software applications.

6. The method of claim 1, further comprising modifying a pre-existing set of suggested recipients in a type-ahead module of the user interface to include the set of potential recipients, wherein the type-ahead module suggests one or more recipients from the set of potential recipients to autocomplete a type-ahead field.

7. The method of claim 1, further comprising receiving configuration information from the user, the configuration information specifying one or more of a source for activities of a user, a maximum age of activities of a user, and a size limit for the number of members of the set of potential recipients.

8. An apparatus for improved type-ahead functionality in a type-ahead field based on activity of a user within a user interface, the apparatus comprising:
an identification module configured to identify a user activity context comprising one or more activities of a user within a user interface, each activity comprising an associated recipient identifier;
a determination module configured to determine a set of potential recipients based on the user activity context, each potential recipient corresponding to one or more associated recipient identifiers from the user activity context; and
a registration module configured to register the set of potential recipients with one or more type-ahead modules of the user interface, wherein the one or more type-ahead modules suggest one or more recipients from the set of potential recipients to autocomplete a type-ahead field managed by the one or more type-ahead modules, wherein the one or more type-ahead modules suggest one or more recipients from the set of potential recipients in response to the user entering one or more characters in the type-ahead field.

9. The apparatus of claim 8, further comprising
a detection module configured to detect a user-initiated selection of the type-ahead field; and
a suggestion module configured to suggest one or more recipients from the set of potential recipients to autocomplete the type-ahead field.

10. The apparatus of claim 8, wherein the determination module further comprises a correlation module configured to correlate the user activity context to the set of potential recipients by mapping one or more associated recipient identifiers associated with the user activity context to the set of potential recipients.

11. The apparatus of claim 8, further comprising a storage module configured to store the set of potential recipients wherein the set of potential recipients is accessible to the one or more type-ahead modules.

12. The apparatus of claim 8, further comprising a prioritization module configured to assign a priority weight to each potential recipient in the set of potential recipients and prioritize the set of potential recipients based on the priority weights.

13. The apparatus of claim 12, wherein the priority weight of a potential recipient is based on one or more of an amount of time spent by the user on an activity associated with the potential recipient, a frequency of the activity associated with the potential recipient, and an amount of time since the activity associated with the potential recipient.

14. The apparatus of claim 8, further comprising a monitoring module configured to monitor one or more software applications of the user interface and identify activities of the user with the one or more software applications.

15. The apparatus of claim 8, further comprising a modification module configured to modify a pre-existing set of suggested recipients in a type-ahead module of the user interface according to the set of potential recipients, wherein the type-ahead module suggests one or more recipients from the set of potential recipients to autocomplete a type-ahead field.

16. The apparatus of claim 8, further comprising a configuration module configured to receive configuration information from the user, the configuration information specifying one or more of a source for activities of a user, a maximum age of activities of a user, and a size limit of the set of potential recipients.

17. A computer program product comprising a computer readable storage medium having computer usable program code executable by a processor to perform operations for improved type-ahead functionality in a type-ahead field based on activity of a user within a user interface, the operations of the computer program product comprising:
an identification module configured to identify a user activity context comprising one or more activities of a user within a user interface, each activity comprising an associated recipient identifier;
a determination module configured to determine a set of potential recipients based on the user activity context, each potential recipient corresponding to one or more associated recipient identifiers from the user activity context; and
a registration module configured to register the set of potential recipients with one or more type-ahead modules of the user interface, wherein the one or more type-ahead modules suggest one or more recipients from the set of potential recipients to autocomplete a type-ahead field managed by the one or more type-ahead modules in response to the user entering one or more characters in the type-ahead field.

18. The computer program product of claim 17, further comprising
a detection module configured to detect a user-initiated selection of the type-ahead field; and
a suggestion module configured to suggest one or more recipients from the set of potential recipients to autocomplete the type-ahead field.

19. The computer program product of claim 17, further comprising a monitoring module configured to monitor one or more software applications of the user interface and identify activities of the user with the one or more software applications.

20. A computer program product comprising a computer readable storage medium having computer usable program code executable by a processor to perform operations for improved type-ahead functionality in a type-ahead field based on activity of a user within a user interface, the operations of the computer program product comprising:
identifying a user activity context comprising one or more activities of a user within a user interface, each activity comprising an associated recipient identifier;
determining a set of potential recipients based on the user activity context, each potential recipient corresponding to one or more associated recipient identifiers from the user activity context;
assigning a priority weight to each potential recipient in the set of potential recipients wherein the priority weight for a potential recipient is based on one or more of an amount of time spent by the user on an activity associated with the potential recipient, a frequency of the activity associated with the potential recipient, and an amount of time since the activity associated with the potential recipient;
prioritizing the set of potential recipients based on the priority weights wherein the priority weight of a potential recipient is based on a relationship between the potential relationship and the user activity context;
registering the set of potential recipients with one or more type-ahead modules of the user interface; and
modifying a pre-existing set of suggested recipients in a type-ahead module of the user interface according to the set of potential recipients, wherein the type-ahead module suggests one or more recipients from the set of potential recipients to autocomplete a type-ahead field managed by the one or more type-ahead modules, wherein the one or more type-ahead modules suggest one or more recipients from the set of potential recipients in response to the user entering one or more characters in the type-ahead field.
